(19) United States
(12) Patent Application Publication
(10) Pub. No.: US 2013/0121580 A1
(43) Pub. Date: May 16, 2013

(54) ANALYSIS OF SERVICE DELIVERY PROCESSES BASED ON INTERROGATION OF WORK ASSISTED DEVICES

(71) Applicants: Wenkai Chen, Austin, TX (US); Amir Geva, Yokneam (IL); Miao He, Beijing (CN); Tao Qin, Beijing (CN); Changrui Ren, Beijing (CN); Lei Yuan, Beijing (CN); Sai Zeng, Yorktown Heights, NY (US)

(72) Inventors: Wenkai Chen, Austin, TX (US); Amir Geva, Yokneam (IL); Miao He, Beijing (CN); Tao Qin, Beijing (CN); Changrui Ren, Beijing (CN); Lei Yuan, Beijing (CN); Sai Zeng, Yorktown Heights, NY (US)

(73) Assignee: International Business Machines Corporation, Armonk, NY (US)

(21) Appl. No.: 13/619,221

(22) Filed: Sep. 14, 2012

Related U.S. Application Data
(60) Provisional application No. 61/558,613, filed on Nov. 11, 2011.
(60) Provisional application No. 61/677,539, filed on Jul. 31, 2012.

(51) Int. Cl. G06Q 10/00; G10L 15/26; G06K 9/18

(52) U.S. Cl. 382/182; 705/7.38; 704/235; 704/E15.045

(57) ABSTRACT

A method of monitoring input devices to discover units of work and type of work includes recording uses of input devices of a computer, analyzing the recorded uses against pre-defined use patterns to determine sets of the recorded uses that correspond to one of a plurality of units of work, and outputting an indicator indicating which of the units of work have occurred. A method of accessing a call center includes performing speech to text transcription on audio recordings from the center, determining an identifier identifying an operator for a call from the text, estimating a phase of the call based on the text, recording ant entry including the identifier, the phase, and a time period of the phase, correlating the entry with another entry including information on an application run during the estimated phase to generate a correlated entry, and determining quality level of operator based on correlated entry.

### CROSS-REFERENCE TO RELATED APPLICATION

This application claims priority to U.S. Provisional Application No. 61/558,613, filed on Nov. 11, 2011, and U.S. Provisional Application No. 61/677,539, filed on Jul. 31, 2012, wherein the disclosures of each are incorporated by reference herein.

### BACKGROUND

1. Technical Field

The present disclosure generally relates to analysis of service delivery processes, and more particularly to the analysis of service deliver processes based on interrogation of work assisted devices.

2. Discussion of Related Art

Examples of businesses that primarily perform services include call centers, data entry services, legal offices, sales departments, software departments, etc. For example, a call center is a facility used by companies to manage client contact through a variety of mediums such as telephone, fax, letter, email, and increasingly, online chat. The productivity of such businesses may be reduced due to various factors such as inaccurate data capturing, low performance management, a frequently varying environment, etc.

As compared to a business that manufactures a product, it can be difficult to evaluate the efficiency of a business that primarily performs services. The efficiency of an employee in such a business may be determined by onsite observation or self reporting. In one example, an on-site supervisor produces a general daily efficiency assessment of each employee based the amount of work product produced (e.g., number of phone calls answered, number of letters written, number of orders processed, etc.). In another example, the employee provides a self-efficiency assessment. However, it can be costly to pay an additional employee to perform these assessments and time-consuming for individual employees to perform their own self-assessments.

Further, self-assessments of efficiency may not be accurate. For example, assume an employee is to manually record completion of each different activity into a different log. Upon completing a particular task, that employee could potentially enter the record into the wrong task completion log. Moreover, self-assessments may omit details that would prevent a supervisor from determining an accurate level of worker efficiency. For example, an employee is likely to omit from her self-assessment that she spent 2 hours playing solitaire or chatting on a social network.

Thus, there is a need for automatic mechanisms for assessing the efficiency of businesses that provide services.

### BRIEF SUMMARY

According to an exemplary embodiment of the invention, a method of monitoring input devices to discover units of work includes recording uses of input devices of a computer, analyzing the recorded uses against pre-defined use patterns to determine sets of the recorded uses that correspond to one of a plurality of units of work, and outputting an indicator indicating which of the units of work have occurred.

According to an exemplary embodiment of the invention, a method of monitoring work activities to determine a measure of efficiency includes monitoring at least one input device of a computer to record usage patterns, matching the recorded usage patterns to input patterns to determine tasks that are performed by the respective input devices, classifying the determined tasks as being one of work or non-work related tasks, and calculating a metric that indicates a proportion of time spent on the work-related and non-work related tasks.

According to an exemplary embodiment of the invention, a method of accessing quality of a call center includes performing speech to text transcription on audio recordings of the call center, determining an identifier that identifies an operator for a call from the text, estimating a phase of the call based on the text, recording a first entry including the identifier, the phase, and a time period of the phase, correlating the first entry with a second entry including information on an application run during the estimated phase to generate a correlated entry, and determining a quality level of the operator based on the correlated entry.

According to an exemplary embodiment of the invention, a method of categorizing units of work and their times includes identifying signature pages from each application page selected on a computer that includes a unique transaction identifier, performing sequential pattern mining during a given period to extract patterns of frequently occurring application events, partitioning another period of application events based on the identified signature pages to generate units of work, scoring each extracted pattern based on how closely the corresponding extracted pattern matches with the each of the units of work, determining whether each work unit is one of a normal case or a deviated case based on the scores, determining starting and ending times of the normal cases, and outputting the starting time, ending time, and an activity type for only the normal cases that are not due to an inadvertent selection of an application.

In a further embodiment, the method conducts post-processing for deviated work units (abnormal cases) to determine the transactions contained in the deviated work units, identifies the starting times, ending times and activity types for each of the transactions contained in the deviated work units, and outputs starting times, ending times, and activity types for each of the transactions.

### BRIEF DESCRIPTION OF THE SEVERAL VIEWS OF THE DRAWINGS

Exemplary embodiments of the disclosure can be understood in more detail from the following descriptions taken in conjunction with the accompanying drawings in which:

FIG. 1 illustrates a high-level block diagram of a system for analyzing services according to an exemplary embodiment of the invention;

FIG. 2A illustrates a method of monitoring input devices to discover units of work according to an exemplary embodiment of the invention;

FIG. 2B illustrates a method of monitoring work activities to determine a measure of efficiency according to an exemplary embodiment of the invention;

FIG. 3 illustrates a high-level block diagram of a system according to an exemplary embodiment of the invention;

FIG. 4 illustrates an example of a user interface of the system of FIG. 3;

FIG. 5 illustrates a flow diagram of the system of FIG. 3 according to an exemplary embodiment of the invention;

FIG. 6 provides graphical illustrations for normal processing and variations;

FIG. 7 illustrates a flow of a tool for classifying units of work and determining theirs times according to an exemplary embodiment of the invention;

FIG. 8 illustrates a method of categorizing work unit that may be performed by the tool according to an exemplary embodiment of the invention; and

FIG. 9 illustrates an example of pseudocode 900 that may be used to reduce noise;

FIG. 10 illustrates a system for analyzing a call center according to an exemplary embodiment of the invention;

FIG. 11 illustrates a method performed by a phase timer of the system of FIG. 10 according to an exemplary embodiment of the invention;

FIG. 12 illustrates a method performed to provide an overall analysis of the call center according to an exemplary embodiment of the invention; and

FIG. 13 shows an example of a computer system capable of implementing the methods and systems according to embodiments of the disclosure.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the present disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

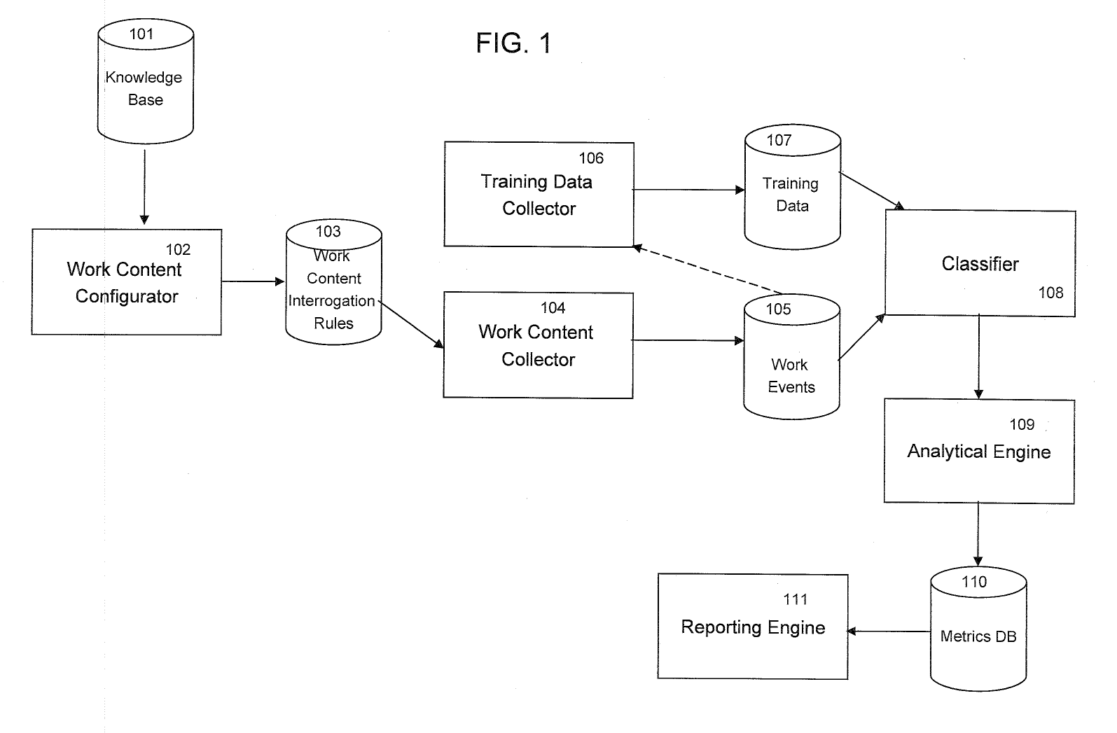

FIG. 1 illustrates a high-level block diagram of a system for analyzing services according to an exemplary embodiment of the invention. The system may include a knowledge database 101, a work content configurator 102, work content interrogation rules 103 database, a work content collector 104, a work events database 105, a training data collector 106, a training data database 107, a classifier 108, an analytical engine 109, a metrics database 110, and a reporting engine 111.

The system can interrogate work assisted devices (input devices) and generate events, which contain work input content, intermediate state content, and output content of user activities and a timestamp. Examples of the input devices include a mouse, keyboard, touch screen, a virtual reality interface, a graphical user interface (GUI), an URL, a browser, an application, a telephone, a cell phone, or other devices that allow one to observe how a user directly interacts with input devices such as a GUI screen recorder or a camera. The data collected by the system can be used to discover a unit of work (e.g., start/end of a unit), classify the type of work, time of the work, etc. Examples of a unit or work include processing an invoice or issuing a payment. Examples of types of the work include invoice processing, payment processing, short break, etc. The system can also classify the waste (non-work activities like social networks, games) or non-value added activities (e.g., breaks), and time at which the waste and non-value added activities occurred.

While FIG. 1 shows several individual databases, the data contained in each of the illustrated databases may be contained in a fewer number of databases or a same single database. Further, the databases may be relational databases such as DB2, Informix, etc. or non-relational database. Examples of non-relational databases include flat files, spread sheets, binary files using data structures, etc.

The knowledge database 101 may include a collection of content types that are available for monitoring. An editor program (not shown) may be provided that enables a user to edit the collection. The content that is available for monitoring may include mouse clicks, keyboard presses, focus changes, touch screen touches, names of computer application programs/processes being run (e.g., solitaire, SAP applications, etc.), types of computer programs being run (e.g., browser, game, email, chat, social network, spreadsheet, calculator, calendar, SAP application, etc.), addresses or names of websites (e.g., uniform resource locator URLs), screen titles or screen text of displayed windows (e.g., a particular order number), idleness of a device (e.g., computer screen locked, keyboard idle, etc.), etc.

The Work Content Configurator 102 is used to define configuration rules to determine what content (e.g., work related or otherwise) needs to be interrogated/extracted due to user activities on work-assisted devices (e.g., a mouse, a keyboard, a touch screen, a virtual reality interface, a graphical user interface, an URL, a browser function, an application function, a telephone input, a cell-phone input, etc.). A user can use the Work Content Configurator 102 to generate interrogation rules from the content types and logical operators. Examples of interrogation rules include a rule interrogating for “mouse clicks” received over “solitaire” and “minesweeper”, a rule interrogating for “keyboard presses” in an input field of a SAP application, a rule interrogating for “URLS” including “games.com” and “fashion.com”, etc. The Work Content Configurator 102 can also enable a user to generate a rule based on the absence of one of the available data types. For example, a user could generate a rule interrogating for no mouse clicks (e.g., !mouse clicks) or no keyboard clicks (e.g., !keyboard clicks) over any input field of a SAP application. The interrogation rules may include any combination of logical operators (e.g., not (!), AND, NAND, OR, XOR, XNOR, NOR, etc.) in conjunction with what is being interrogated. For example, a user could generate a rule interrogating for (!mouse clicks over solitaire) AND (keyboard clicks over a SAP application). The user may also specify that a particular interrogation rule is only active for a certain length of time. For example, a user could generate a rule interrogating for (!mouse clicks) or (!keyboard clicks) over SAP applications during time (9:00-12:00). Please, note that the above provided rules are merely examples, as embodiments of the inventive concept are not limited to any particular rule.

Once the rules have been generated, they can be stored in the Work Content Interrogation Rules database 103 so they can be used by the Work Content Collector 104. The Work Content Collector 104 may be used to collect content from inputs of the monitored devices, and generate events with the content and timestamps, which can be used to classify the type of action being performed (e.g., work related/non work related). The Work Content Collector 104 monitors a computer system for inputs that satisfy the rules within the Interrogation Rules database 103. For example, if the active rule set is only concerned with mouse button clicks over certain programs, the Work Content Collector 104 could effectively ignore keyboard presses or mouse button clicks over all other programs.

The Work Content Collector 104 may include one or more monitoring programs that monitor inputs captured by input event handlers of the operating system based on use of input devices of the computer system, or user generated input event handlers that may be configured to capture the inputs, or events generated by programs that monitor computer program usage and website browsing.

For example, the Work Content Collector 104 could monitor system or user input event handlers for mouse clicks, keyboard clicks, focuses (e.g., focus in/focus out), touch screen touches, inputs from virtual reality interface devices such as a motion sensing device, etc.

A mouse click event from a mouse event handler could indicate a particular mouse button (e.g., left button, middle button, right button, wheel, etc.) was selected over a particular location, program, or field of the program. For example, when a graphical user interface is constructed, a user generated mouse event handler can be added to each selectable graphical object (e.g., text field, button, etc.) such that a predefined function is called whenever the object is selected, which is passed an event structure or a pointer to the event structure with information about what was selected (e.g., the name of the graphical object, the value of the graphical object, a numeral identifier, an X-Y coordinate, etc.), what did the selecting (e.g., middle mouse button), what kind of selection was made (e.g., single click, double click, etc.), and what program made the selection (e.g., solitaire, SAP application, etc.). However, since access to user generated event handlers may be limited, this disclosure will focus, on more easily accessible input event handlers such as those produced by the operating system and the monitoring programs.

For example, a mouse event handler of the operating system could only include information indicating that a mouse click occurred over a particular screen location. The Work Content Collector 104 may be configured to query for additional information to determine what action the mouse click corresponds to generate an input event. For example, the Work Content Collector 104 may perform a screen capture of the screen upon receiving the mouse click information or perform the screen capture periodically based on a parameter (e.g., user configurable). The Work Content Collector 104 can then perform an optical character recognition (OCR) on all or a portion of the screen capture around the clicked coordinate in the mouse event. For example, an OCR of a screen capture after a mouse click over solitaire would generate text such as “solitaire” and characters or numbers of the cards (e.g., 4, J, K). The Work Content Collector 104 can then add this text to the data structure of an input event it generates. The Work Content Collector 104 may also insert a timestamp into the input event. The Work Content Collector 104 may also insert a type identifier into the input event indicating the type of input event (e.g., a mouse click). The Work Content Collector 104 may either generate the timestamp or append the timestamp from the mouse click event generated by the operating system, if it is available.

A keyboard event from a user generated keyboard event handler could indicate the computer application being typed into, the name of the text field that is being edited, the text being typed, etc. A keyboard event from the operating system may include less information, such as only the text that is being typed or possibly only an indication that a key has been pressed. The Work Content Collector 104 can obtain the object handler to the associated graphical components in response to the keyboard event, and interrogate the graphical components to get additional information such as what text has been entered, or perform a screen capture in response to the keyboard event and perform an OCR to determine text of the program in which the text is being entered. In another embodiment, the Work Content Collector 104 can determine what program or window is being typed into from a prior input event. For example, if the prior mouse click event indicated that a SAP application was selected, then it is likely that the text is being entered into an input field (e.g., a purchase order field) of the same SAP application. Thus, the Work Content Collector 104 can generate an input event indicating that a keyboard click occurred within the input field of the SAP application and the time at which it was entered. The Work Content Collector 104 may also insert a type identifier into the input event indicating the type of input event (e.g., a keyboard input or click).

A focus event from a user generated focus event handler may indicate that a particular computer program or graphical input field (e.g., text field, option menu, pull-down menu, toggle button, button, list, table, etc.) has either gained focus or lost focus, and potentially the location selected or moved over to gain or lose focus. The Content Collector 104 can determine what program or window has gained focus from interrogating the graphical objects through the operating system, or doing a screen capture about the location of focus and doing an OCR on the result. The content of the focused graphical objects can be obtained from the object handlers through the operating system, or from the OCR along with a timestamp, which can then be inserted into an input event. The Work Content Collector 104 may also insert a type identifier into the input event indicating the type of input event (e.g., a focus).

A touch screen event from a user generated touch screen event handler may indicate a location touched on the screen, or the particular computer program or an identifier of the graphical field that was touched. A touch screen event from the operating system could include less information such as only the location of the touch. The Work Content Collector 104 can determine what program was touched or which graphical objects were touched by interrogating the operating system, or performing a screen capture around the location touched and then performing an OCR to generate text, which can be inserted into the structure of an input event along with a timestamp and the type of the input event (e.g., touch press).

The Work Content Collector 104 can passively examine the browsing history of loaded browser programs to determine what websites have been visited by the computer system. The Work Content Collector 104 can also actively monitor packets on ports associated with the internet (e.g., port 80) to determine the internet addresses in which packets are being received from or sent to, to determine the URLS of visited websites. The Work Content Collector 104 can also perform periodic screen captures and OCRs to determine what websites are being accessed. For example, a string from an OCR including text such as “http://www” likely indicates the name of the website currently being visited. The Work Content Collector 104 can then generate an input event including the website visited, and a timestamp.

The Work Content Collector 104 can also monitor what programs are currently active by monitoring application windows in foreground through the operating system, or using screen captures and OCR or by using operating system commands. For example, using a program or commands to access the foreground window handlers can yield the title of the program being run. For embedded windows such as SAP running in a Citrix window, using OCR of a screen capture can yield the title of the embedded program. Further, certain operating systems have commands that produce a list of the programs that are currently being run. For example, the Linux operating system has a ‘ps’ command that gives a snapshot of the current processes being executed. The snapshot includes a list of the named processes that are running and may include the start time of the process, its run duration, etc. The information captured (e.g., process name, process start time, process duration) for a single or multiple processes can be inserted into the structure of an input event along with a timestamp.

The Work Content Collector 104 can also monitor the computer system for idle activity (e.g., screen is currently locked, keyboard is idle). For example, when the screen of the computer screen locks from lack of user interaction, the operating system generates an event that indicates that screen has locked. The Work Content Collector 104 can generate an input event in response to the screen locked event that indicates the screen is a locked along with a timestamp. The Work Content Collector 104 can also infer that a keyboard or mouse or other input device is idle if a certain period of time has elapsed without the corresponding input. For example, if no keyboard events have been received for a predetermined period (e.g., 10 minutes, 20 minutes, etc.), the Work Content Collector 104 can generate an input event indicating the corresponding input device (e.g., keyboard, mouse, etc.) is idle for the corresponding time period

The Work Content Collector 104 stores the generated input events into the work event database 105. While the stored input events are referred to as work events herein, each may indicate a work or a non-worked related activity. For example, one work event could indicate a content of “mouse clicks over solitaire” occurred at a time stamp of “12:34” while another work event could indicate a content of “mouse clicks over SAP application” occurred at timestamp of “13:34”. If several same events occur consecutively, the Work Content Collector 104 can combine them into a single work event. For example, a combined work event could indicate that a content of “450 mouse clicks over solitaire” occurred during time period “11:00-13:00”.

Each of the input events may also specify the identity of the user that triggered the event. For example, the Work Content Collector 104 can query the computer system for the identity of the active user and insert its identity into each input event it generates. The Work Content Collector 104 may monitor the computer system for login or logout events to determine what user is currently logged on. The Work Content Collector 104 can then insert the login information into subsequently generated input events.

The Training Data Collector 106 can be used to generate training data 107 from a portion of the work events. The Training Data Collector 106 can generate the training data 107 from manual feedback or according to predetermined rules.

For example, a user observing a work event of “mouse clicks over solitaire” or “visits to games.com” during period “13:00-14:00” could categorize the work event as “waste” and provide that feedback to the Training Data Collector 106, which would generate training data 107 that marks (labels) such as a “waste” example. In another example, a user observing a work event of “screen locked” or “keyboard idle” during period “10:00-10:15” could generate training data 107 that marks such as a “break” example. In a further example, a user observing a work event that appears work related could mark such as a “work” example; or more particularly a “transactional work” example or an “application specific work” or a “non transactional work” example. Examples of transactional work may include purchase order processing, a payment run, etc. Examples of application specific work include an email task using lotus notes, outlook, etc. Examples of non-transactional work may include data backup, issue resolution, etc. In a further example, a user observing that the work of the same transaction or work of the like content occurs during different time slots could mark such as a “rework” example, or more particularly as a “rework transactional work” example or a “rework application specific work” example, or a “rework non-transactional work” example.

Once a pre-determined amount of training data 107 is acquired, it can be used to train the Classifier 108, which can classify subsequent received work events based on the training data 107. For example, subsequent works events that are similar to the examples provided in the training data 107 can be classified by the classifier 108 as having a similar classification (e.g., waste, work, break, rework, etc.), or given an unknown classification otherwise.

The analytical engine 109 can perform an analysis to compute metrics or key performance indicators KPIs, which can be stored in the metrics database 110. KPIs help organizations understand how well they are performing in relation to their strategic goals and objectives. The metrics and KPIs can be used by a business for process improvement and user performance improvement. Examples of different types of analysis that may be performed by the engine 109 include i) process trend and stability analysis, ii) practitioner tenure analysis, workload-full time equivalent FTE analysis, iii) workload profiling, iv) consolidation and prediction, v) benchmark analysis, vi) productive vs. non productive (work related, waste, break, rework) identification, vii) multi-level root cause analysis, etc. For example, in a productive vs. non productive identification, the analytical engine 109 could produce a metric that indicates 90% of the work day is work related, 5% is wasted, 5% are breaks, and of the work related activity, 10% are due to re-work.

The reporting engine 111 can present (display or print) the metrics and the KPIs. The reporting engine 111 can also aggregate the metrics and KPIs at various levels ranging from system, to people, to process, to account, etc.

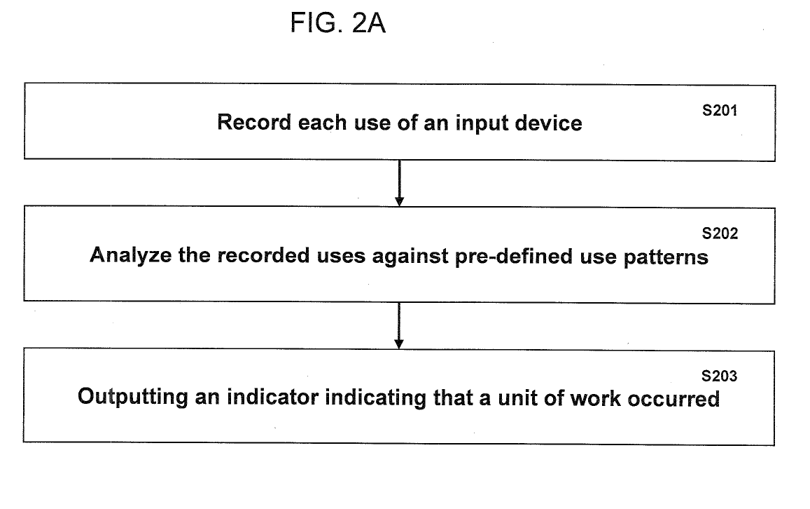

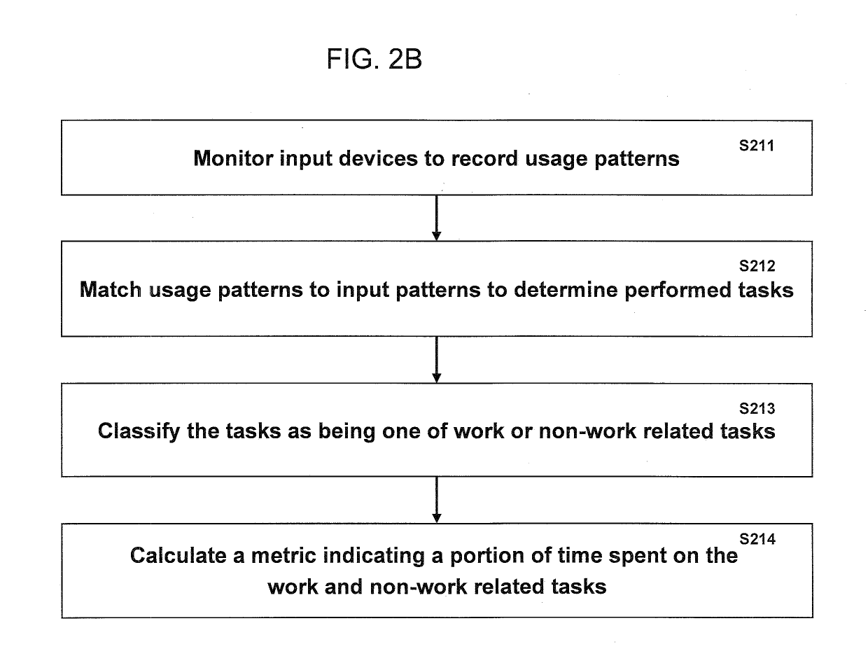

FIG. 2A illustrates a method of monitoring input devices to discover units of work according to an exemplary embodiment of the invention. The method includes recording each use of an input device (S201), analyzing the recorded uses against pre-defined use patterns to determine whether a series of the recorded uses corresponds to a unit of work (S202), and when the series does correspond, outputting an indicator indicating that the unit of work has occurred (S203). The indicator may indicate the type of work that has occurred, the time at which the work occurred, and the length of time the work occurred over, etc. The use patterns need not correspond to work, and can instead indicate non-work related activities. Thus, whenever a series of input events matches a pre-defined use-pattern, it can be classified as particular unit of work, or a particular unit of non-work.

The uses of the particular input devices that are to be recorded (e.g., mouse, keyboard, etc.) and the rates at which they are to be recorded can be defined in the work content interrogation rules database 103, and the recording can be performed by the work content collector 104. The pre-defined use patterns may be stored in the training database 107. A pre-defined use pattern may be stored along with its type of work or non-work (e.g., invoice processing, payment processing, game, social network etc.). For example, a mouse click on a invoice order window, followed by keyboard clicks in input fields, and then a mouse click over a save button could be stored as one use-pattern having type ‘invoice processing’, whereas a keyboard click entering socialnetwork.com, followed by keyboard clicks on a window entitled ‘social network’ could be stored as a second use-pattern having type ‘social network’.

FIG. 2B illustrates a method of monitoring work activities to determine a measure of efficiency according to an exemplary embodiment of the invention. The method includes monitoring at least one input device of a computer to record usage patterns (S211), matching the usage patterns to input patterns to determine tasks that are performed by the respective input devices (S212), classifying the determined tasks as being one of work or non-work related tasks (S213), and calculating a metric that indicates a proportion of time spent on the work-related and non-work related tasks (S214). The method may further include determining the user that has performed each task and calculating a metric that indicates a proportion of time spent on the work-related and non-work related tasks for that user.

The monitoring can be handled by the above described Work Content Collector 104. The input events generated by the monitoring may identify the device (e.g., device identifier, device name, device address etc.) and the action performed by the input device (e.g., interacted with browser, email program, game program, SAP application, directed browsing to a particular web address, etc.), include a timestamp or time period, and the user that caused the input event. The idle input events generated by the monitoring may list, their action as a null action. The idle input events will be generated when there is no any action (e.g. mouse moving, mouse clicking, keyboard striking etc.) on devices beyond a pre-defined time threshold. The usage patterns will become apparent once they are matched against known input patterns, which may also be stored in a database (e.g., database 107).

In an embodiment, an input pattern includes a sequence of input device events triggered by actions by one or more input devices on a computer that corresponds to a given task. For example, when a purchase order is filled, a data entry clerk may enter data into various input fields, such as for the identity of the party the product is being sold to, a purchase order number, a purchase order date, etc. Thus, the task of entering a purchase order could have an input pattern of using a mouse to select on a purchase order window of a SAP application, using a keyboard to enter data into each of the above-identified input fields, and then using a mouse to select a save button on the purchase order window. Thus, if the above-described matching (e.g., see block S212) discovers that a usage pattern of mouse and keyboard events corresponding to the above input pattern is present within the record data, it could be inferred that a task of entering a purchase order has occurred. The period of time taken to perform the task can be calculated from the timestamps of the first and last events associated with the task. For example, if a mouse click over the purchase order window occurred at 12:01 and a mouse click occurred over the save button of the purchase order window at 12:05, it could be inferred that the task of entering a purchase order took 4 minutes.

The classifying of the determined tasks (e.g., block S213) as being one of work or non-work related tasks may be performed by the classifier 108 or by referring to a table (e.g., a lookup table). For a given period, an overall metric may be calculated from a first tally of the number of work related tasks and a second tally of the number of non-work related tasks. For example, assuming each task takes an equal amount of time, the amount of overall waste during a given period can be determined by dividing the second tally by the first tally. However, when tasks do not each take an equal amount of time, those tasks that take longer can be weighted greater than those tasks that take less time. For example, if one non-work related task occurs during three quarters of a given hour and one work-related task occurs for the remaining ¼ hour, the amount of waste could be considered 75%. In another embodiment, for a given period, a metric per user may be calculated from a third tally of the number of work related tasks performed by a given user and a fourth tally of the number of non-work related tasks performed by the given user.

The method may further provide statistics on the kinds of work related or non-related tasks that were performed, which indicates the method decomposes the work related or non-work related time at a finer level. For example, if 10% of time is wasted and 90% of time is work related, the statistics could indicate that 5% of the time is wasted on games, 5% of the time is wasted on visiting non-work related websites, 45% of the time is spent on word processing and 45% of the time is spent on email programs. For example, each task can be compared against a list that describes the type of the non-work task (e.g., game, browsing, social network, etc.) or the type of the work task (e.g., SAP application, email, etc.) to determine how much time was spent doing of type of non-work or work task.

Some tasks may not fall into work related or non-work related categories, and can be excluded. For example, tasks that correspond to valid break periods (e.g., no keyboard or mouse clicks during 12:00-13:00) can be ignored when determining how much time or what percentage of time is wasted or spent working.

The methods of FIG. 2A or 2B may further include outputting (e.g., displaying or printing) the determined units of work/non-work or tasks in a report. Elements in the report may identify the users that performed the units of work, units of non-work, or the tasks, the time period during which they were performed, and its classification (e.g., work, waste, break, invoice processing, game, etc.). The report may be formatted as an electronic message and sent across a computer network (e.g., internet) for remote display or printing.

In an alternate embodiment, instead of the tasks being classified as being work related or non-work related, they may be classified as being productive or non-productive, or as being billable or non-billable. For example, even if a service business is determined to be performing primarily business related tasks, it could still be an unsuccessful business if an excessive number of these work related tasks are non-billable tasks. Thus, using the number of determined billable and non-billable tasks; a metric can be generated that indicates the percentage of a work day spent on billable tasks. The classifier 108 may be trained as necessary to classify tasks as being billable or non-billable tasks. For example, the training data collector 106 is configured and the training data can be generated from observing prior work events, such that patterns of input events that indicate a billable task are labeled/marked billable and other patterns of input events are labeled/marked non-billable.

Businesses such as call centers may be inefficient due to a number of factors. Self reporting tools may be introduced to improve call center performance. Such tools can help to collect detailed activity time data and volume data manually to support practitioner performance improvement, workload scheduling and optimization, process benchmarking, best practice implementation, etc. However, as discussed above, self reporting tools may not be accurate. Thus, an exemplary embodiment of the invention provides an automatic tool to assess the efficiency of a call or contact center. The tool may be used to collect detailed data in a real-time manner, which may reduce error data and improve the collected data quality. Further, use of the tool may improve practitioner efficiency.

The tool is configured to classify and delimit activity in service delivery processes of a call or contact center. The tool may include an extract, transform, and load (ETL) process. For example, the tool can extract data from activity events of the call or contact center, transform the extracted data to fit operational needs, and load the transformed data into an end target (e.g., a database). The tool performs activity classification to classify a type of activity performed, and time delimitation to automatically delimit the start and end time of the activity. In an embodiment, the tool identifies the practitioner (e.g., user) that performed the activity. The tool can count the number of transactions processed for each classified activity type.

A classification may be performed using transaction based algorithms (e.g., ID3, C4.5, a Classification and Regression Tree CART, a Chi square-Automatic-Interaction-Detection CHIAD, a Quick, Unbiased, Efficient, Statistical Tree QUEST, etc.). However, such algorithms make classifications based on unordered features without considering non-deterministic times of repetitive feature appearance. In service delivery processes, a proper classification needs activity classification based on sequential featured events and requires time delimitation with the consideration of feature appearance. Hence, according to an exemplary embodiment of the invention, a transaction-based system is introduced herein to handle service delivery processes.

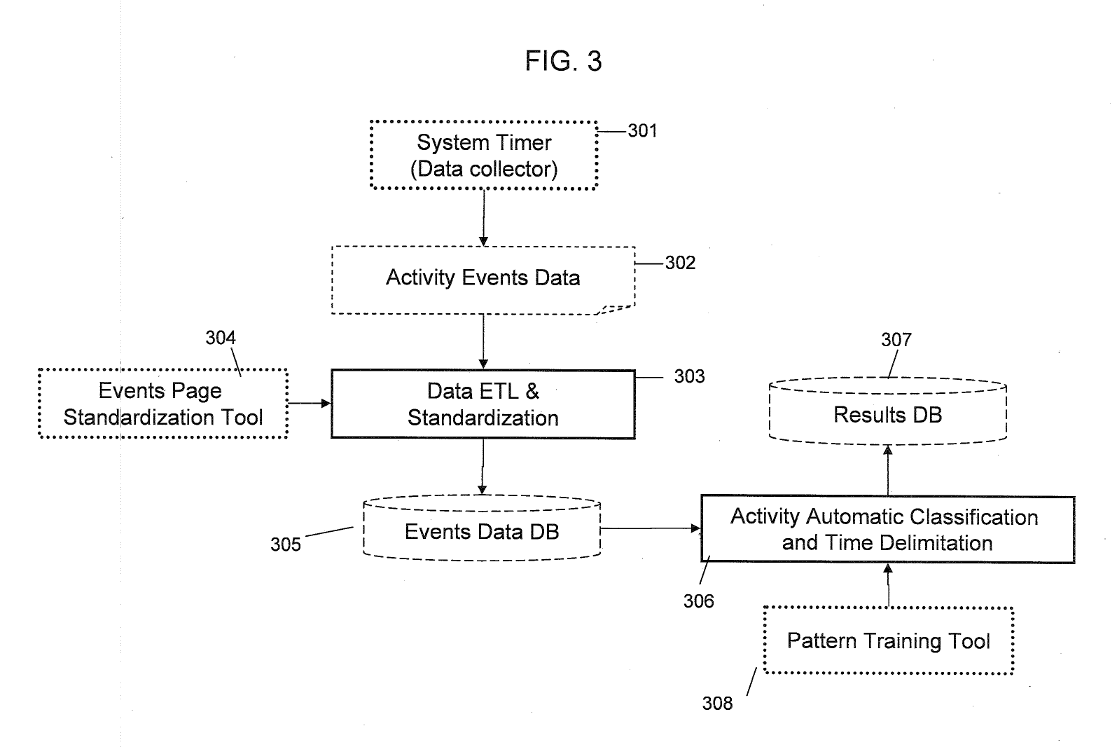

FIG. 3 illustrates a high-level block diagram of the system according to an exemplary embodiment of the invention. Referring to FIG. 3, the system includes a System Timer 301 that generates activity events data 302, an ETL process 303 that cleans, transforms, and standardizes the input events generated by System Timer 301 for storage in an Events Database 305 based on data the activity events data 302. An Event Page Standardization Tool 304 can be pre-configured by studying the features of each input events and used to standardize input events. An Activity Classification and Time Delimitation process 306 that generates classified and time delimited results for storage in a Results Database 307 based on input events in the Events Database 305, and a Pattern Training Tool 308 can be used for training the Activity Classification and Time Delimitation process 306.

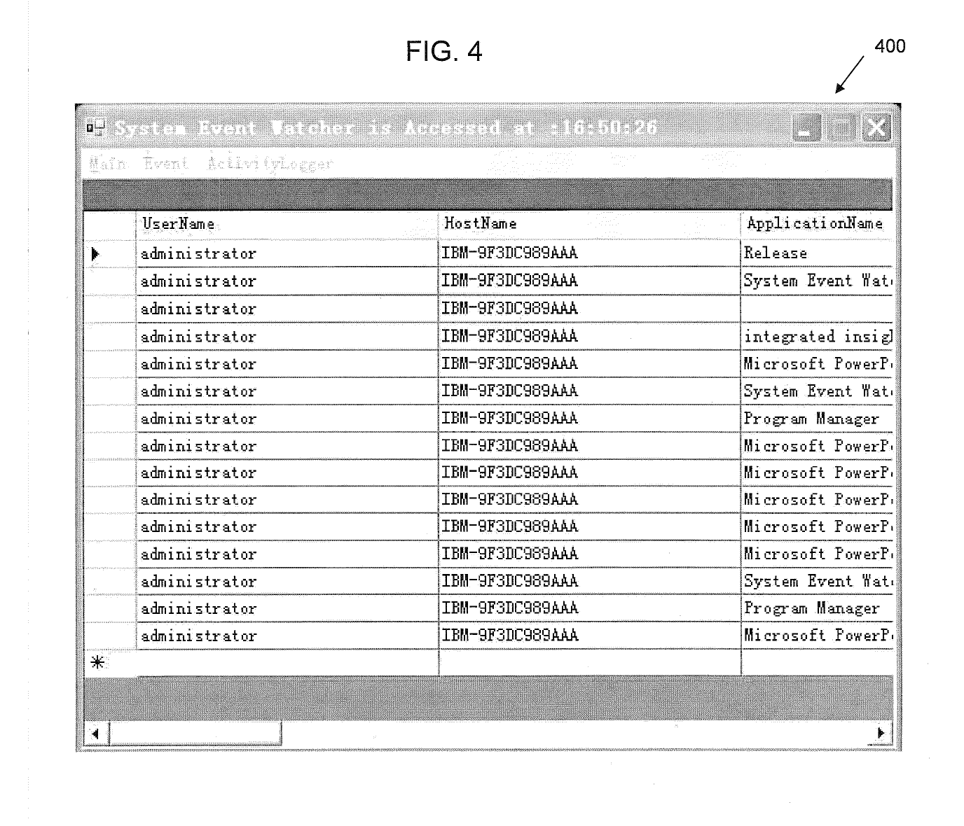

The System Timer 301 is a light weight application tool that can capture user behaviors on a computer. The System Timer 301 periodically collects data such as computer and user information (e.g., username, hostname), activated page information (e.g., computer program or name/title of window activated), time stamp information (e.g., date/time at which window was activated), and outputs structured data into a file (e.g., a text file). For example, this output data (e.g., activity events data 302) may include rows and columns of data, where each row corresponds to a different event. For example, one row could include data such as a username, the name of the computer, the name of the application activated by the user, the date/time the program was activated, etc. FIG. 4 is an example of a user interface 400 of the System Timer 301. For example, as shown in FIG. 4, the user interface 400 enables a user to view what applications have been performed by each user and an what computer the application was run. Although not shown in FIG. 4, each row may additionally include the time/date at which the application was activated.

The ETL process 303 may be configured to filter out activity events data 302 with quite short time duration based on a pre-defined time threshold. For example, if an application was only activated for a few seconds, it could have been activated in error, and can be excluded. The ETL process 303 can compare the time periods of input events in the activity events data 302 with a pre-defined parameter (e.g., 1 second, 5 seconds, etc.) to determine whether an input event should be excluded. The ETL process 303 may also be configured to adjust timestamps of input events based on the active time zone. For example, if input events are initially time stamped with Coordinated Universal Time and the Classification Process 308 is trained using local times, the time stamps of the input events should be converted to local time to prevent erroneous classifications.

The Event Page Standardization Tool 304 can be used to transform records of the events data 302 into records of a standard format. For example, an application window can have components, and each component can have sub-components. For example, a pull-down menu in an application window could correspond to the components, and the individual option buttons of the pull-down menu could correspond to the sub-components. For example, one could activate a word processing program, then select the tools menu, and then select a track changes option within the tools menu. The activity events data 302 could then include one record for the activation, a second record for the selection of the tool menu, and a third record for the selection of the track changes option. Although not shown in FIG. 4, the Standardization Tool 304 could format the second and third records such that the second record includes a column labeled as a “component” (e.g., a component of the word processing program) and the third record includes a column labeled “sub-component” (e.g., a component of the tools menu) and another column filled with the standard name of the second records to record the relationship between them. For example, an individual row of FIG. 4 could be expanded to illustrate actions performed within an application window.

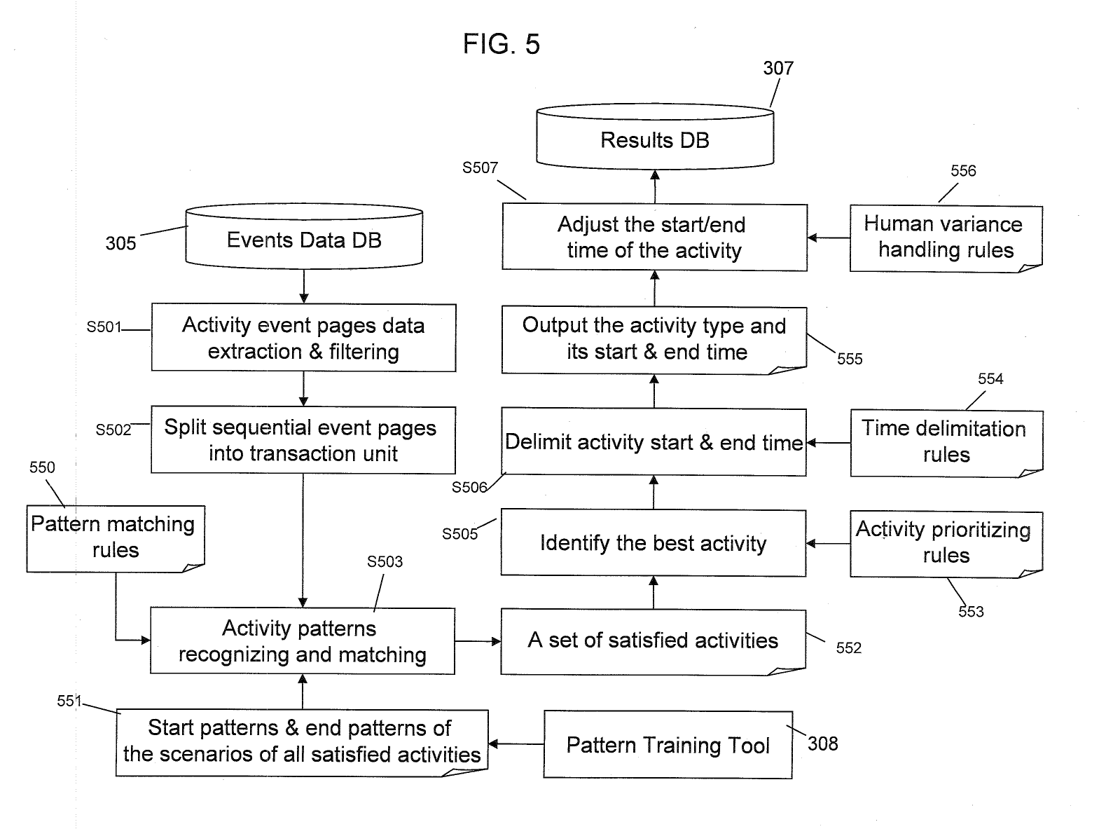

FIG. 5 illustrates a flow diagram of the system of FIG. 3 according to an exemplary embodiment of the invention. Referring to FIG. 5, the flow diagram includes performing extraction and filtering of activity events data from the Events Data database 305 (S501). For example, records from the Activity Events Data 302 can be separated into different groups based on the user that performed the activity. The data can be further grouped by the period (e.g., by day) the activity was performed by that user.

The flow diagram continues with a step of splitting sequential event pages into a transaction unit (S502). For example, transaction IDs can be determined and a sequence of the records can be split into a transaction unit based on the appearance of a transaction ID.

The flow diagram continues with a step of performing recognition and matching of activity patterns using pattern matching rules 550 and start patterns and end patterns of scenarios of activities 551 to generate a set of satisfied activities 552 (S503). An activity scenario includes a start pattern and an end pattern. The start pattern is defined to delimit the start time of an activity and the end pattern is defined to delimit the end time of the activity. The start pattern and end pattern are applied together to identify an activity type. The start and end patterns may be generated by the Pattern Training Tool 308.

The flow diagram continues with the Activity Automatic Classification and Time Delimitation process 306 performing steps of performing identification of the best activity based on activity prioritizing rules 553 (S505), and delimitation of activity start and end times based on time delimitation rules 554 to output the activity type and its start and end time (S506).

The start or end time of the activity can then be adjusted based on human variation handling rules 556 for storage of an adjusted set of satisfied activities into the Results database 307 (S507). The adjustment may reduce noises and disturbances caused by varying human behaviors such as random clicking on pattern pages. In an exemplary embodiment of the invention, the human variation handling further includes at least one of: (i) handling the repetitive visits, which refers to the behavior that a practitioner repetitively click the same applications, (ii) handling the inadvertent clicking, which refers to the behavior that a practitioner clicks unintended applications in a particular activity, but the clicked applications are typical signal for processing some other activities, (iii) handling incomplete processing, which refers to the behavior that a practitioner only process part of the full procedures, (iv) handling batch processing, which refers to the behavior that a practitioner process several transactions of the same activity type, and bundle some of the steps, (v) handling interleaved processing, which refers to the behavior that a practitioner process transactions of different types in an interweaving way, and (vi) handling combined processing, which refers to the behavior that a practitioner process multiple transactions of different types with some steps omitted.

In an exemplary embodiment of the invention, a method is provided to automate back office activity monitoring. In the method, desktop application usage of practitioners are monitored and captured. The monitoring can be tailored to account for a certain percentage of a work period of an individual (e.g., 90%). Based on the application usages, an activity classifier and a timer are developed.

In this embodiment, an activity is the most granular level in the process taxonomy. Each activity has a particular and unique succession of processing procedures, and different activities have different succession of processing procedures.

In this embodiment, a transaction is an instance of a particular activity type. A transaction has a many-to-one relationship with a particular activity type. For example, if there is activity labeled “hotel invoice processing”, there could be one transaction with invoice number 123, another with invoice number 456, where each have the same activity type (e.g., invoice processing), but with different transaction IDs (e.g., invoice numbers).

The activity classifier and timer are used to identify the correct activity type for each transaction and determine the start and end time of each transaction. A learning module initially learns the sequential application usage patterns of each activity type. The learning module takes application events with a class label (e.g., the activity type) as input and implements one or more sequential pattern mining algorithms. Next a testing module classifies and times a practitioner's work.

However, handling various human behavior variations and noises may lead to an imperfect matching between actual application usages with patterns learnt from standard operations. As discussed above, these variations and noises may include (partial) batch processing, random clicks in applications, incomplete processing procedures, combined or interleaved processing, etc. If not handled properly, these variations and noises could have a significantly negative impact on accuracy of classification and timing.

A tool implemented with the above activity classifier and timer may eliminate or reduce the manual effort of “self reporting” and “floor auditing”, accurately count the number of transactions processed for each activity, and have a positive affect on the behavior of practitioners. For example, the tool may be used to discover non-standard or exceptional operations, which may not yet have been documented in desktop procedures.

The timer may include a system timer capable of capturing the starting and ending times of every application event, machine idles, and keyboard idles. In this embodiment, an event refers to a non-switching stay on one application page. For example, the system timer would record the starting time as soon as one opens a social media application (e.g., Facebook™) in their browser. Then, upon switching to another social media application (e.g., Twitter™) after a period of time has elapsed (e.g., 10 seconds) while staying on the initial social media application, the system timer records the ending time of the initial social media application. The system timer can record the starting time of the subsequent social media application to be the same as the ending time of the initial social media application. A machine idle may refer to an event where a desktop is locked, and keyboard idle may refer to an event where the computer is left on during a period in which no input is received (e.g., no clicking of the mouse, no typing on the keyboard, no touching of the touch screen, etc.).

The below Table 1 provides a list of human behavior variations.

TABLE 1

| | Variation | |
|---|---|---|
| Index | type | Description |
| Var-1 | Incomplete | Only early or later steps of a transaction are |
| | processing | spotted |
| Var-2 | Batch | Multiple transactions of the same activity type |
| | processing | form a work unit, where some of the steps |
| | | (featured application pages) are triggered in a |
| | | batch (e.g., ten invoices opened one after another |
| | | before they are processed one by one) |
| Var-3 | Interleaved | Multiple transactions of different activity types |
| | processing | form a work unit, where the required steps |
| | | (featured application pages) of each transaction |
| | | appear in an interleaving way |
| Var-4 | Combined | Multiple transactions of different activity types |
| | processing | form a work unit, where not all the required steps |
| | | (featured application pages) can be found for at |
| | | least one of the activities |

The below Table 2 provides a list of human behavior noises.

TABLE 2

| Index | Noise Type | Description |
|---|---|---|
| Noi-1 | Repetitive | Since it can be difficult for a practitioner to |
| | visits | complete everything on an application page |
| | | without switches, a non-deterministic number of |
| | | visits to the same page may occur |
| Noi-2 | Inadvertent | A practitioner may inadvertently click on certain |
| | clicks | featured application of other activity types that |
| | | are not relevant to the transaction under |
| | | processing |

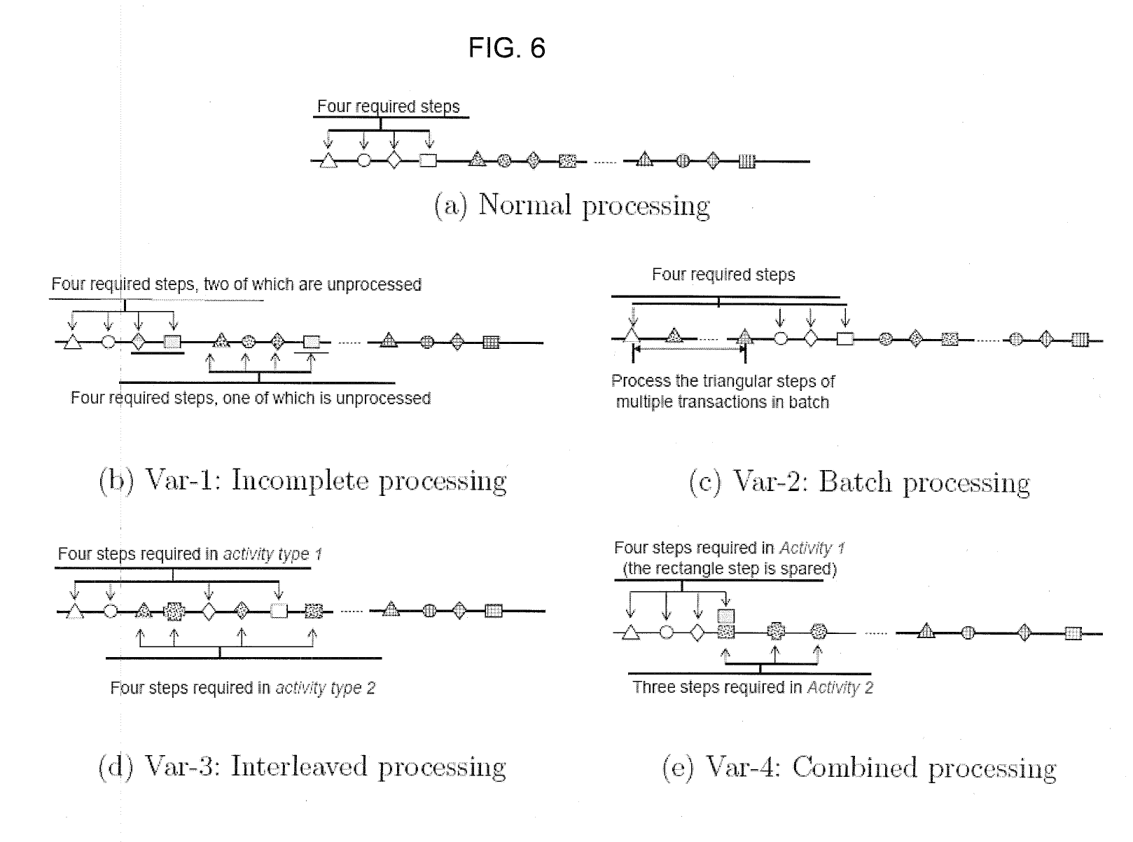

FIG. 6 provides graphical illustrations for normal processing and variations, where each distinct shape represents a distinct application page (e.g., a processing step), and shapes with the same fill correspond to an end-to-end transaction. Transactions are of different activity types if their shape sequences are not identical. End-to-end transaction processing that exactly follow documented desktop procedures are considered normal. Patternized deviations from the normal cases are considered variations, while noises are predictable unpredictable fluctuations around the normal case without pattern governance.

An exemplary embodiment of the invention provides a tool that makes integrated use of knowledge discovery techniques including sequential pattern mining, a scoring function, and a confidence interval. The tool embeds two sequential pattern mining modules for normal and deviated cases, respectively. Henceforth, deviated cases are used to refer to cases with human behavior variations described in Table 1. The normal sequential pattern mining is conducted only once, with training data captured during the time veteran staffs are doing their work, which strictly follow the desktop procedures. The training for the deviated cases, on the contrary requires iterative efforts, since practitioners cannot provide the full set of variations. The training data set for deviated cases is expanded with application events going through the tool, but remaining unclassified.

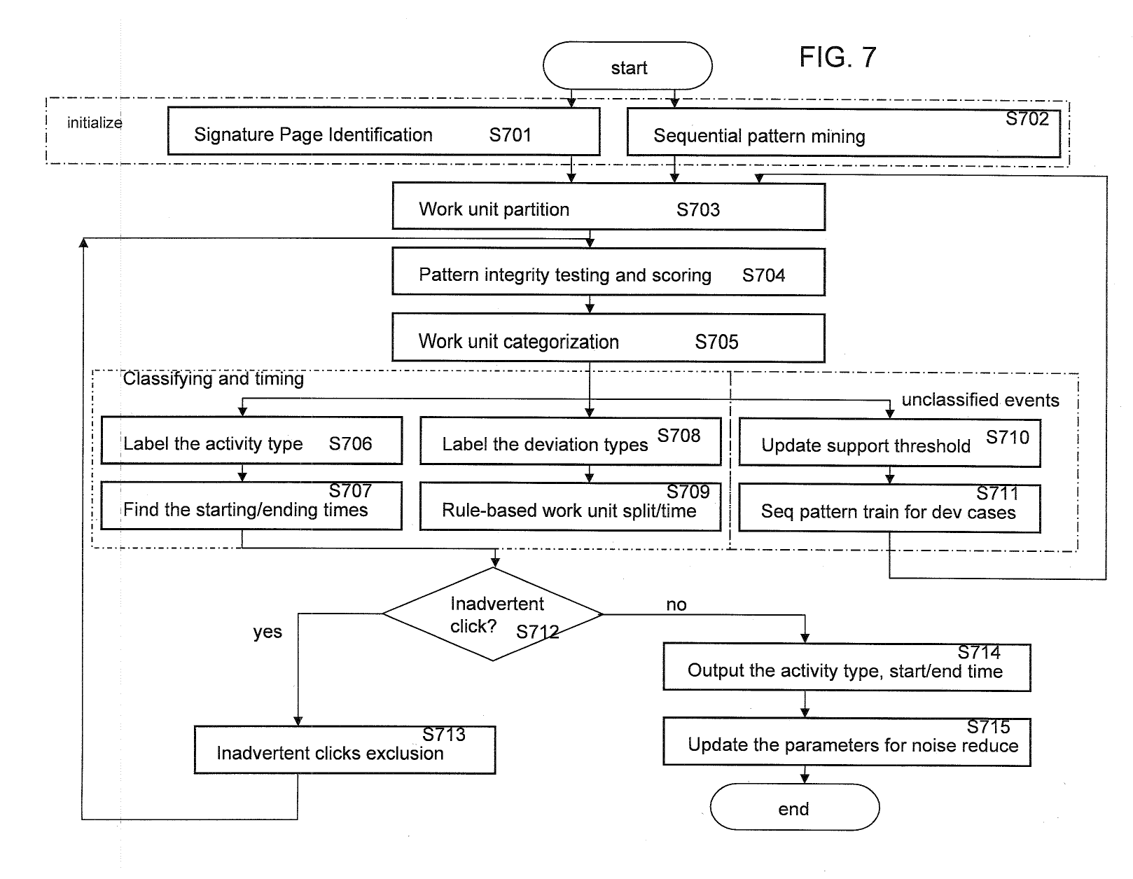

FIG. 7 is an illustration of the tool, according to an exemplary embodiment of the invention. Referring to FIG. 7, the tool undergoes an initialization phase, which includes signature page identification (S701) and sequential pattern mining for normal cases (S702). In an exemplary embodiment, a unique transaction ID included within the application page is determined during the signature page identification. The initial sequential pattern mining extracts frequent sequential application patterns for normal transactions cycles. The below provides an example used to demonstrate a flow of the tool, where each letter represents a different application and letters with a subscript (e.g., transaction ID) are the identified signature pages. The below Table 3 provides data for the example.

TABLE 3

| | |
|---|---|
| Normal pattern | {ABCD_{X}EFG}, {HI_{X}J}, {ECD_{X}E} |
| (learnt by mining) | |
| Interleaved pattern | {ABCD_{X}HI_{X}EFGJ}, enclosed |
| (learnt by mining) | activities are |
| | {ABCD_{X}EFG} and {HI_{X}J} |
| Input sequence | {ECD₁EABCD₃HI₈EFGJ} |

The tool partitions a period (e.g., a whole day) of application events by signature pages or signature page combinations (S703). The events around a signature page are considered as belonging to the same transaction. In the example based on Table 3, the three signature pages could partition the input sequence into three work units, i.e., {ECD₁EABC}, {EABCD₃H}, and {HI₈EFGJ}. Alternatively, the sequence could have been partitioned into two work units, i.e., {ECD₁EABC} and {EABCD₃HI₈EFGJ} since the “D-I” signature combination may form an interleaved work pattern learnt beforehand. Note that the application between two signature pages (or signature page combinations) is considered as possibly belonging to both transactions at this phase. For example, the EABC between signature pages D₁ and D₃ are temporarily put into both work units. This step generates partitions in all the possible ways and feeds them into the following steps. In this example, partitions will be generated in two ways where one includes three isolated work units, and the other includes one isolated work unit plus one interleaved work unit.

Next pattern integrity testing and scoring is performed (S704). This step uses frequent patterns of normal and deviated cases to test if they occur around the signature pages or signature page combinations appropriately. The appropriateness means featured pages occur, and occur in the expected order. At least one embodiment allows “partial matching”, which does not require a work unit containing 100% application pages in a pattern or arranging featured application events exactly as the pattern sequence. The partial matching may be used because incomplete processing cases (Var-1) cannot have all the featured application events, while batch processing (Var-2) cannot guarantee that all the transactions contain all the featured events. Further, use of partial matching hedges against the risk of high generation error as a result of overfitting, which means that patterns learnt in the training phase might only work well for the training set, but are not optimal for the testing set.

However, partial matching can generate multiple candidates. It is common that activities processed by the same team (back office) are related with each other, which leads to application sharing to some extent. For example, activity invoice auditing may be a prerequisite to the activity of invoice payment, and both activities visit the same application to retrieve invoices. Therefore, application sharing plus “partial matching” implies multiple candidate patterns. A score function may be defined according to Equation 1 shown below:

$$Score = \frac{number o \overline{f} appropriately matched pages}{number of pattern pages} \qquad [ Equation 1 ]$$

The score function is designed to choose the best from the candidate patterns. Each candidate pattern is tested and scored as shown the exemplary Table 4 below.

TABLE 4

| Work Unit | Pattern to Test | Score |
|---|---|---|
| {ECD₁EABC} | {ABCD_{X}EFG} | 3/7 = 42.9% |
| | {ECD_{X}E} | 4/4 = 100.0% |
| {EABCD₃H} | {ABCD_{X}EFG} | 4/7 = 57.1% |
| | {ECD_{X}E} | 2/4 = 50.0% |
| {ECD₁EABC} | {HI_{X}J} | 3/3 = 100.0% |
| {ECD₁EABC} | {ABCD_{X}HI_{X}EFGJ} | 10/10 = 100.0% |

A first theorem is posited that when a transaction can either be extracted from an isolated work unit or part of an interleaved (combined) work unit obtained in the partition phase, the appropriately matched application pages in the former case will always be a subset of the later (hereinafter referred to as “Theorem 1”). The way work units are partitioned by the tool makes Theorem 1 self-evident. In the above example, the transaction {HI₈J} can be either extracted from the isolated work unit {HI₈EFGJ} or the interleaved work unit {EABCD₃HI₈EFGJ}. Further, {HI₈EFGJ} is a subset of {EABCD₃HI₈EFGJ} as Theorem 1 states.

A second theorem is posited that when a transaction can either be extracted from an isolated work unit or part of an interleaved (combined) work unit, it can always be split from the interleaved (combined) work unit with a score not lower than the score of the isolated case (hereinafter referred to as “Theorem 2”). Theorem 1 establishes that the number of appropriately matched pages split from the interleaved (combined) work unit must be equal to or more than the number of appropriately matched pages in the isolated page. Given that the appropriately matched page count is the numerator in Equation 1, and the denominators are the same for both cases, Theorem 2 is determined to be valid.

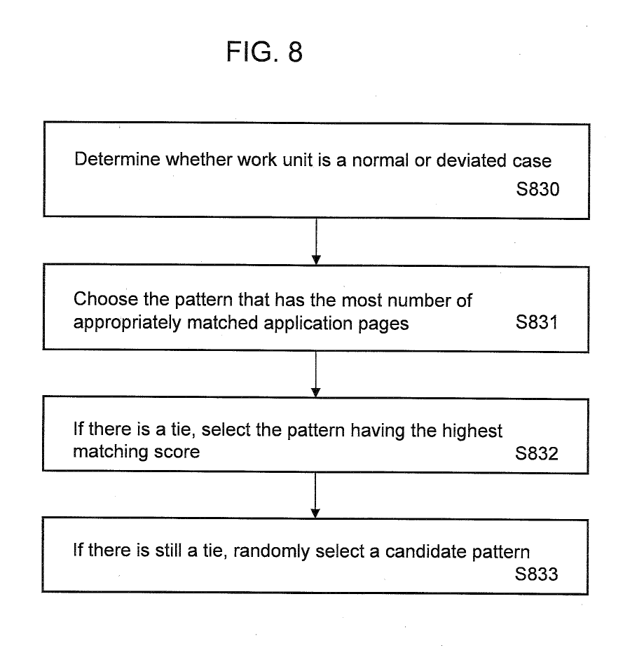

The tool performs work unit categorization based on the prior partitioning and scoring (S705). Work units are categorized by applying the method shown in FIG. 8. Referring to FIG. 8, the method includes determining whether a work unit is a normal case or a deviated case (S830) and choosing the pattern that has the most number of appropriately matched application pages appearing in the work unit under concern (S831). If two patterns have the same number of matched application pages, there is a tie, and one of these patterns can be selected that has the highest matching score as calculated via Equation 1 (S732). If these two patterns both have the same matching score, then one of them can be selected at random as the candidate pattern (S733).

For a normal transaction, which has a complete cycle, the work unit categorization (block S705) labels it with the activity type. For a deviated case, the work unit categorization (block 705) points out the variation type and enclosed activities. For example, the work unit {EABCD₃HI₈EFGJ} has variation type “interleaved work unit” and contains two interleaving activity types {ABCD_{X}EFG} and {HI_{X}J}. Using block 731, work unit {ECD₁EABC} is selected and pattern {ECD_{X}E} is associated with the work unit. By prioritizing pattern {ABC_{X}HI_{X}EFGJ} over pattern {ABCD_{X}EFG} plus pattern {HI_{X}K} according to block 730, the work unit {EABCD₃HI₈EFGJ} is labeled as an interleaved case.

The tool additionally includes a section for classifying and timing. The normal cases determined by block 703 are fed to block 706, the deviated cases determined by block 703 are fed to block 708, and the cases that do not correspond to either are fed to block 710. A normal case is assigned the activity type binding with the pattern selected in block 702 (S706). To find the starting and ending time, the “farthest boundary” principle may be employed, which adopts the earliest starting page and latest ending page in the work unit to delimit the transaction cycle (S707). The principle is designed to offset the noise brought by the fact that practitioners cannot always finish all the work on the same page without switching, or Noi-1 in Table 2. The deviated cases are assigned the deviation type binding (S708). After splitting a deviated case into sub-units according to signature and pattern pages, the “farthest boundary” principle is applied to identify the tentative transaction starting and ending time (S709).

The events that do not correspond to a normal or a deviated case (e.g., unclassified events) can be examined by domain experts and practitioners to determine their proper labels for training. The threshold of the support for the iterative mining may be adjusted by observing the variation frequencies (S710). Then sequential pattern training can be performed for the cases the experts determine to be the deviated cases (S711). The below example assumes the complete cycle for activity 1 is ABCDEFG, that the complete cycle for activity 2 it is HIJKLMN, and there exist two common interleaved working styles such as ABCD|HIJ|EGF|KLMN and ABCDE|HIJ|FG|KLMN that approximately make up 75% and 12.3% of the interleaved cases, respectively. Then, the threshold of support could be set no larger than 12.3% if the second variation deserves identification, otherwise the threshold can be raised to narrow the search space.

For a normal case where a starting and ending time was determined (see block 707), we determine whether an inadvertent click caused the case (S712). If the case was determined to have been caused by an inadvertent click, a method is performed to exclude the case (S713). The method uses two adaptive parameters (e.g., maxSpan and maxGap) to deal with the inadvertent clicking (Noi-2) given Noi-1 has been handled in the classifying and timing section with the “farthest boundary” principle. The parameter maxSpan restricts the cycle type of a particular activity type, while maxGap confines the interval between two featured application pages under a certain threshold. A transaction cycle time exceeding maxSpan calls for a double check as a result of its abnormally longer processing time, implying that it has either been incorrectly delimited or classified with an erroneous activity type.

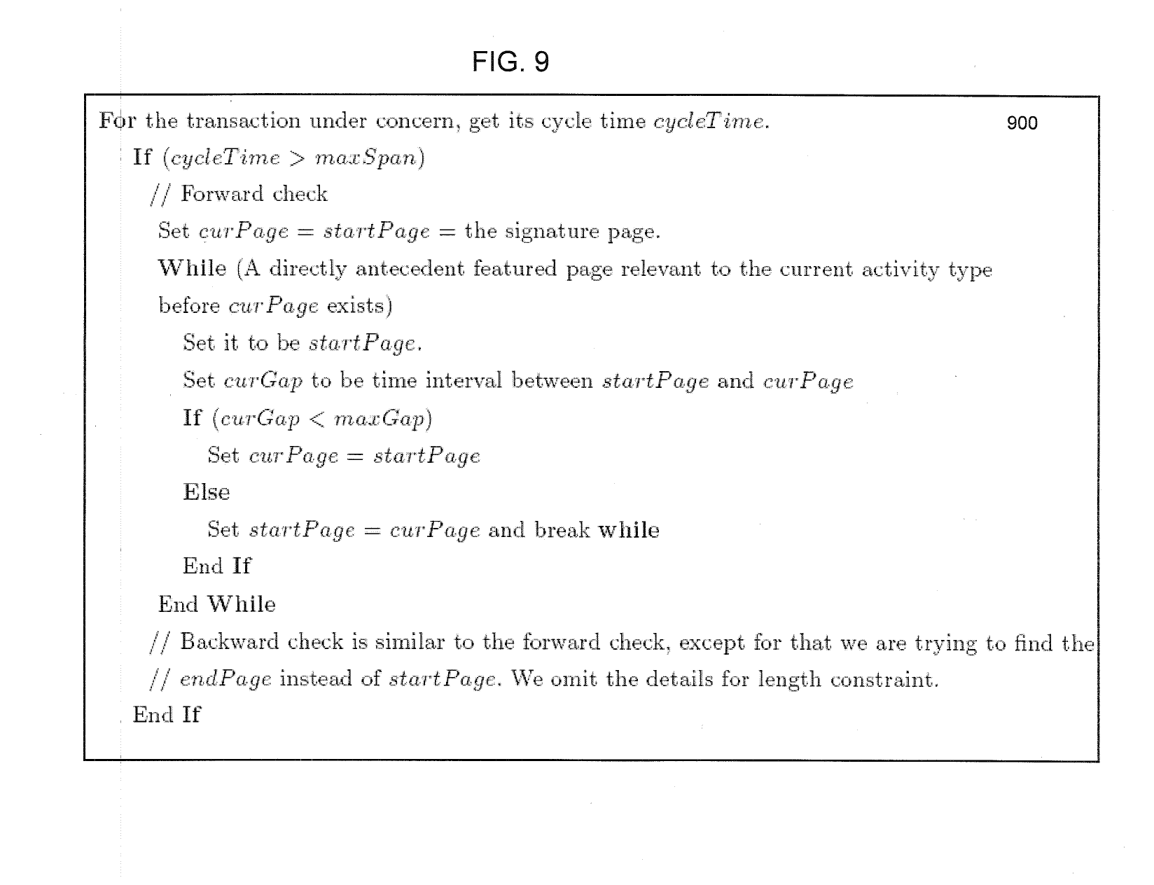

FIG. 9 illustrates an example of pseudocode 900 that may be used to reduce noise. The parameter maxSpan strikes a balance between solution time and accuracy. An extremely large maxSpan is incapable of detecting and excluding inadvertent clocks for more accurate timing, while setting maxSpan too small leads to case-by-case checks, which are time consuming.

In the next example, assume two activity types with sequential patterns ABC_{X}D and BC_{X}D. At first, the working time is classified into type 1 because of block 731, but then the noise reduction phase excludes A when it takes a longer time to arrive at B from A as compared to the maxGAP time. Then, the trimmed work unit is sent for pattern testing and scoring to block 704 for reclassification.

If the click that caused the case was determined to be valid in block 712, the method proceeds to block 714. The class label, starting and ending time points of each transaction are output (S714). Further, the maxSpan and maxGap parameters are updated (S715). The parameters may be updated by constructing one-sided confidence intervals and incorporating the newly identified transactions. For each activity type i, the average cycle time X̅i and the standard deviation σᵢ may be calculated to determine the parameter maxSpanᵢ as shown by the below Equation 2,

maxSpanᵢ= X̅i+zασᵢ/\sqrt{nᵢ}, [Equation 2]

where α is the significance level, n₁ is the sample size, z_{α} is the value that makes P{Z<=z_{α}}=1−_{α}, and Z˜N (0,1), where Z is shown by Equation 3 as follow:

$$Z = \frac{( {\overline{X}}_{i} - {μ}_{i} )}{{σ}_{i} / \sqrt{{n}_{i}}} . \qquad [ Equation 3 ]$$

The parameter maxGap can be generated in real time in block 713 since the time interval between two featured pages differs among activities and applications. The upper bound can be calculated for each application page similar to maxSpan, and the upper bounds of all the applications can be summed between two featured application pages to be maxGAP, as shown in the pseudocode 900 in FIG. 9.

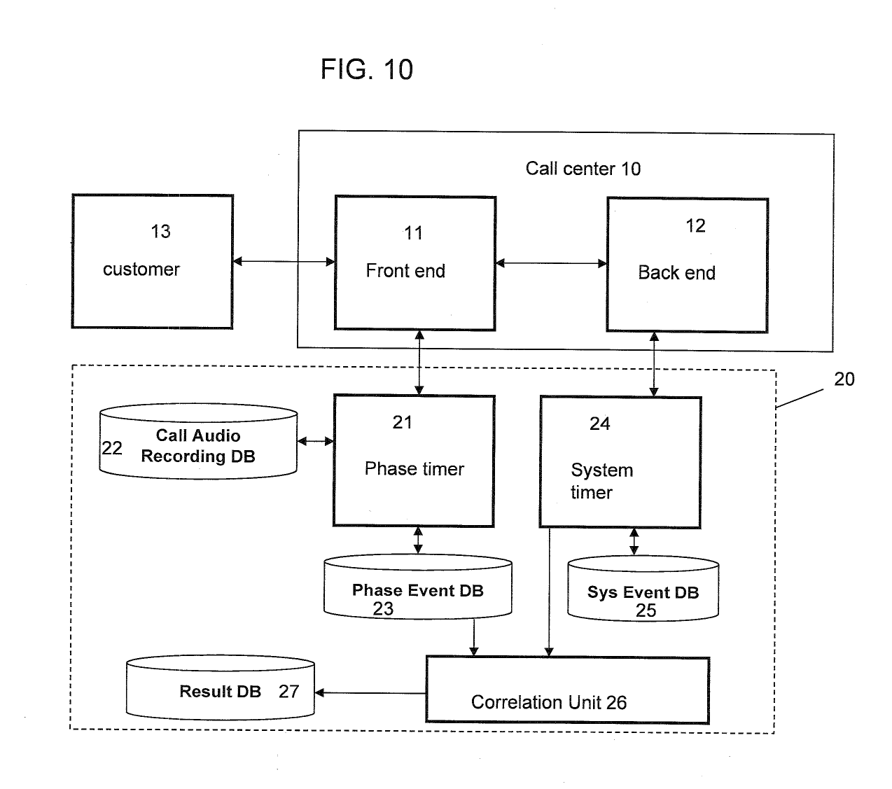

FIG. 10 illustrates a customer 13 interfacing with a call center 10 that includes a front end 11 and a back end 12. An example, of the front end 11 includes a telephone operator answering a phone call from the customer 13. An example of the back end 12 is the computer system that the operator is using to handle the request of the customer 13. FIG. 10 also illustrates a system 20 according to an exemplary embodiment of the invention, which is configured to analyze the actions performed by the Call Center 10. Referring to FIG. 10, the system 20 includes a Phase timer 21, a Call Audio Recording database 22, a Phase Event database 23, a System Timer 24, a System Event database 25, and a Correlation Unit 26, and a Result database 27.

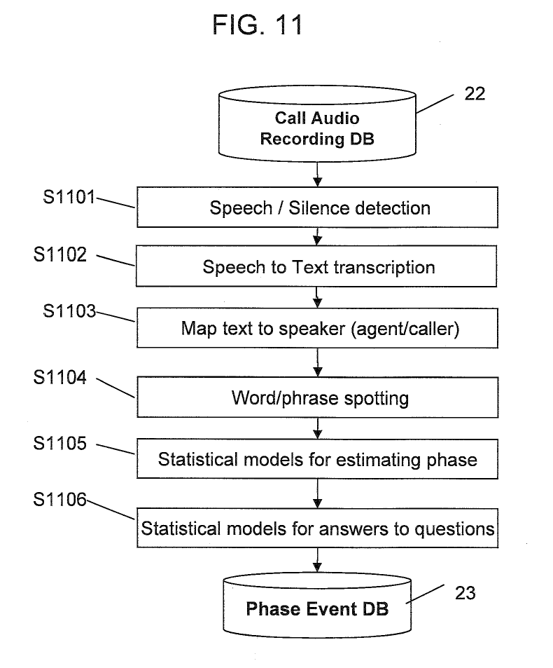

FIG. 11 illustrates a method that may be performed by the phase timer 21 to analyze the actions performed by the call center 10, according to an exemplary embodiment of the invention.

Referring to FIG. 11, the method includes detection of speech and silence based on audio recordings stored in the Call Audio Recording database 22 (S1101), speech to text transcription (S1102), mapping an instance of text or silence to a speaker (e.g., agent/caller) (S1103), performing word/phrase spotting of the text uttered by the corresponding speaker (S1104), using a statistical to model to estimate a phase of the call based on the words and phrases spotted (S1105), and using a statistical model to infer information about the phase for storage in the Phase Event database 23 (S1106).

For example, the call recordings can be segmented into distinct phases such as a greeting phase, a verification phase, a question phase, a back-end interaction phase, an answering phase, a closing phase, etc. However, not all phases may be present and descriptors for each of the may be changed. Further, any of the listed phases could be broken up into sub-phases with their own unique descriptors. In the greeting phase, the front-end 11 (e.g., an operator) verbally greets the customer 13. If the verification phase is present, the operator verbally asks the customer 13 for personal information, which can be used by the operate access the customer account. In the question phase, the operator verbally inquires about the nature of the customer's call (e.g., account balance request, installation request, etc.). In the back-end interaction phase the operator interacts with a back-end computer (e.g., 12) to retrieve the information requested by the customer 13. In the answering phase, the operator verbally responds to the customer 13 based on the retrieved information. In the closing phase, the operator gives the customer a closing greeting assuming that the customer 13 has no more questions.

As discussed above (e.g., S1105), a statistical model can be used to determine which phase a call is currently in based on the words or phrases that have been spotted. For example, the statistical model could indicate phrases such as “hello” and “good morning” are likely to indicate the greeting phase, while phrases such as “can I have your name” and “can I have your date of birth” are likely to indicate the verification phase. A classifier (e.g., a computer program) can use the statistical model to classify the spotted words or phrases as being one of the phases. Once a phase has been identified, an event is recorded into the Phase Event database 23 that includes the identity of the operator, the phase of the call, the start time of the phase, the end time of the phase, the duration of the phase, etc. For example, the event record could indicate that a particular operator engaged in the greeting phase for 30 seconds, engaged in the verification phase for 1 minute, etc. The event record may also include customer identifier information (e.g., customer name, phone number, address, etc.

The classifier can also determine what types of information the operator gave to the customer based on the phrases uttered and the determined call phase. For example, in the answering phase, the statistical model could indicate that the phrase “wait time” is likely to indicate that the operator advised the customer about the time, or that the phrase “self help” is likely to indicate that the operator advised the customer that there are self help options available. Thus, the event recorded in the Phase Event database 23 can further include these information types (e.g., operator x, during greeting phase advised customer y about wait time). The statistical model can also be used to determine whether the operator is engaging in inappropriate conversations. For example, the statistical model could indicate that it is likely an operator has been inappropriate in a call when certain phrases are spotted (e.g., curses) or if the volume of the operator exceeds certain acceptable levels (e.g., from yelling). For example, the event recorded can further include a type that indicate whether an operator has acted appropriately or inappropriately (e.g. operator x, during the question phase, acted inappropriately in a call with customer y.

If a silence is detected during one of the phases, information about the silence can be added to the record for that phase. For example, the record can indicate the period of the silence and when the silence began. Brief silences (e.g., 5 seconds) can be omitted from the record.

The efficiency or quality of a particular operator can be determined by evaluating the records stored in the phase event database 23. For example, the ratio of the amount of a call where there is silence to the amount of call where there is active speech can be used as one measure of the efficiency of the operator. In another example, the quality of an operator can be accessed by comparing the length of each of the phases of the call against pre-defined expected lengths. Further, the quality may be adjusted based the types of information given by the operator that correspond to the policies of the call center. For example, assume an operator is initially graded a 1.0 based on the speed of their answers and it is the company's policy to advise of the wait time during the greeting phase. Further, assume that advising for wait time is assigned a weight of 0.1. Thus, this operator could receive a grade of 1.1 or 0.9. A table of weights may be stored in the system 20 for making these adjustments (e.g., advised wait time=0.1, advised self-help=0.2, acted inappropriately=−0.5, etc.).

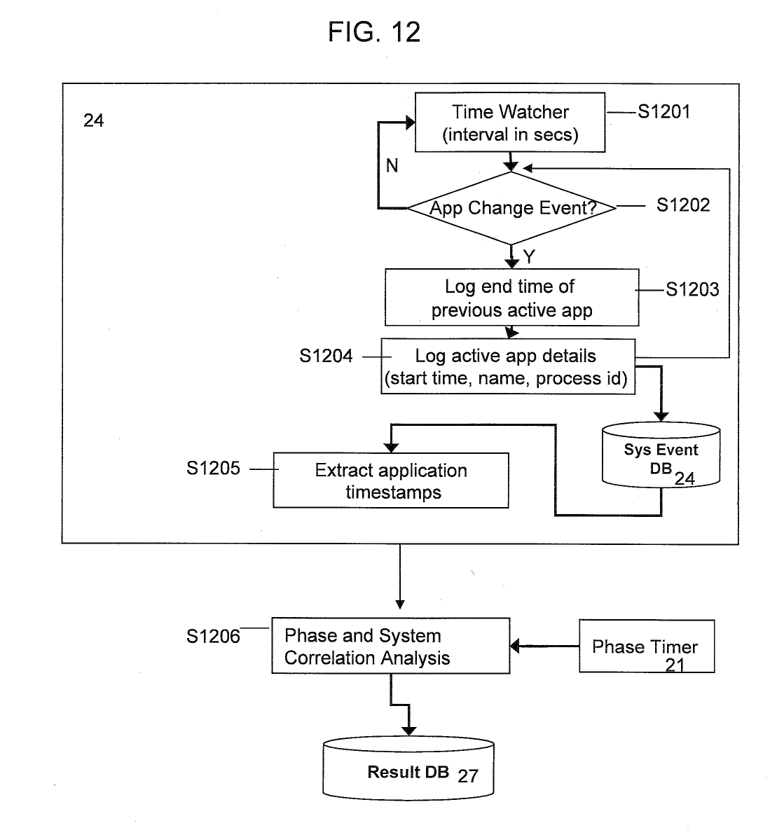

FIG. 12 illustrates a method performed by the System Timer 24, and a method to correlate data output by the System Timer 24 with data output by the Phase Timer 21 to provide an overall analysis of the Call Center 10, according to an exemplary embodiment of the invention.

Referring to FIG. 12, the method includes determination of a timer watch interval (e.g., in seconds) (S1201) and determination of an application change event (S1202). For example, when an application is activated it is watched (monitored) for a period of time. If no change event is present, the current application is watched for another one of the determined intervals. If a change event is present (e.g., activation of new application), an end time is logged for the previous application (S1203). Next, the active application details of the new application are logged (e.g., start time, name, process ID, etc.) (S1204). If the new application ends, the end of the new application is logged, and then all of the information (e.g., start and end time, name, etc.) for the new application can be recorded as an event in the Sys Event database 25 (S1204). The logging of application details such as the application name may include performing a screen capture of the screen followed by an OCR to determine the application name. The data of the records (e.g., timestamps, application name, time period, etc.) stored in the System Event database 25 and the data of the records (e.g., operator, call phase, time stamp, information types) stored in the Sys Event database 25 can be periodically extracted for output to the correlation unit 26 (S1205). The correlation unit 26 can then perform a phase and system correlation based on the extracted data for storage in the Result database 27 (S1206).

The correlation may include determining which applications correspond to which phases of the call. For example, if solitaire was activated during the answer phase, it would explain the excessive periods of silence the customer experienced. Records can be added to the Result Database 27 based on the correlation. For example, one record of the Result Database could indicate the identity of the operator, that the greeting phase took 30 seconds and included advice on self-help, and that answering phase involved use of a database program. Thus, the records of the Result database 27 may include data in records of the Phase Event database 23 and data in records of the Sys Event database 25.

The records of the Result database 27 may be analyzed by the system 20 to determine how efficient each call phase is, and the overall efficiency of an operator. For example, if a call phase included activation of an unauthorized application or access to an unauthorized website, that call phase could be given a lower efficiency level. Each call phase could be given a grade, and the grades could be totaled to arrive at an overall score for each operator. Operators receiving scores above a particular threshold grade could be classified as competent, while those receiving scores below the threshold could be classified as warranting further training.

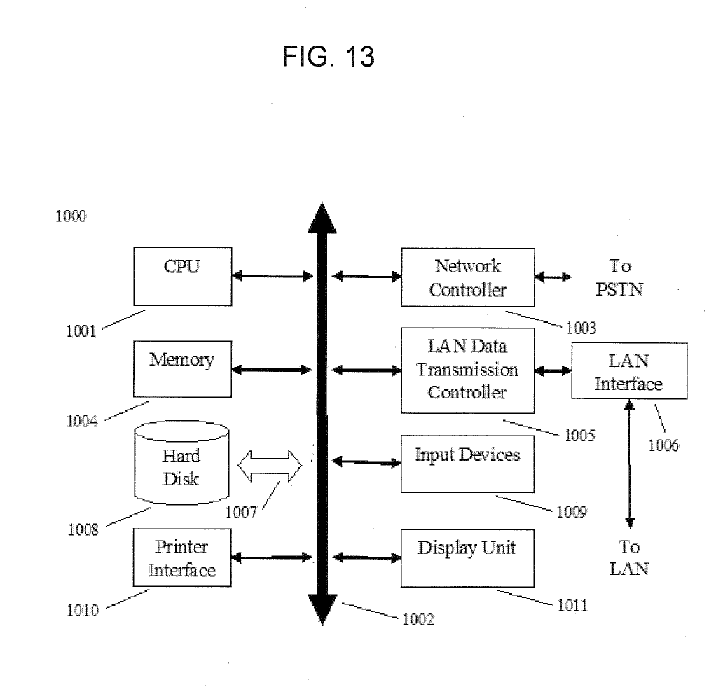

FIG. 13 illustrates an example of a computer system, which may execute any of the above-described methods or house any of the above-described systems, according to exemplary embodiments of the disclosure. For example, the methods, interfaces or systems of FIGS. 1-13 may be implemented in the form of a software application or computer program running on the computer system. Examples of the computer system include a mainframe, personal computer (PC), handheld computer, a server, etc. The software application may be stored on a computer readable media (such as hard disk drive memory 1008) locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk 1008, via a link 1007. For example, CPU 1001 may be the computer processor that performs the above described methods.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of monitoring input devices to discover units of work, the method comprising:
recording uses of input devices of a computer;
analyzing the recorded uses against pre-defined use patterns to determine sets of the recorded uses that correspond to one of a plurality of units of work; and
outputting an indicator indicating which of the units of work have occurred and the starting and ending time of the units of work.

2. The method of claim 1, wherein the input devices include at least one of a mouse, a keyboard, a display, a touch screen, a virtual reality interface, a graphical user interface (GUI), an URL, a browser, a telephone, and a cell phone.

3. The method of claim 1, wherein the indicator indicate times at which the units of work have occurred.

4. The method of claim 1, wherein the units of work include a work related task and a non-work related task.

5. The method of claim 1, wherein at least one of the pre-defined use patterns is a series of input events along with a type of the work unit.

6. The method of claim 1, wherein each recorded use identifies the input device that was used and a time at which the input device was used.

7. The method of claim 1, wherein each recorded use identifies a user that used the corresponding input device.

8. The method of claim 1, further comprising:
recording non-uses of the input devices; and
analyzing the recorded non-uses against pre-defined non-use patterns to determine whether sets of the recorded non-uses correspond to a period of waste or a break period.

9. The method of claim 1, wherein the recording comprises:
performing a screen capture of a display of a computer;
performing optical character recognition on the screen capture to generate text; and
recording the use based on the generated text.

10. The method of claim 1, wherein the recording comprises:
interrogating graphical objects of a display of a computer;
capturing actions and text in the graphical objects to generate text; and
recording the use based on the generated text.

11. The method of claim 9, wherein the text indicates that a particular website address has been visited by a user of the computer.

12. The method of claim 1, wherein the recording comprises:
adding a software event handler to monitor use of the input devices; and
recording a use whenever the software event handler is triggered.

13. A method of monitoring work activities to determine a measure of efficiency, the method comprising:
monitoring at least one input device of a computer to record usage patterns;
matching the recorded usage patterns to input patterns to determine tasks that are performed by the respective input devices;
classifying the determined tasks as being one of work or non-work related tasks;
delimiting the determined tasks by finding out its start and end time;
handling human variations; and
calculating a metric that indicates a proportion of time spent on the work-related and non-work related tasks.

14. The method of claim 13, wherein the human variation handling further comprises at least one of i) handling incomplete processing, ii) handling batch processing, iii) handling interleaved processing, iv) handling combined processing, v) handling repetitive visits, and vi) handling inadvertent clicking.

15. The method of claim 13, wherein the input devices include at least one of a mouse, a keyboard, a display, a touch screen, a virtual reality interface, a graphical user interface (GUI), an URL, a browser, a telephone, and a cell phone.

16. The method of claim 13, further comprises:
determining an identity of the user that has performed each task; and
calculating a metric that indicates a proportion of time spent on the work-related and non-work related tasks for that user.

17. The method of claim 13, wherein the monitoring comprises adding a software event handler to monitor activities of each input device.

18. The method of claim 13, wherein the monitoring comprises:
performing a screen capture of a display of the computer;
performing object character recognition on the screen capture to generate text; and
recording the usage patterns based on the generated text.

19. A method of accessing quality of a call center, the method comprising:
performing speech to text transcription on audio recordings of the call center;
determining an identifier that identifies an operator for a call from the text;
estimating a phase of the call based on the text;
recording a first entry including the identifier, the phase, and a time period of the phase;
correlating the first entry with a second entry including information on an application run during the estimated phase to generate a correlated entry; and
determining a quality level of the operator based on the correlated entry.

20. The method of claim 19, wherein estimating the phase comprises:
deriving a phrase from the text; and
selecting a target phase of a statistical model that includes a plurality of different target phases, wherein the selected target phase indicates the phrase is likely to correspond to the target phase.

21. The method of claim 19, further comprising:
estimating a type of information uttered by the operator during the call; and
adding the type to the first entry.

22. The method of claim 21, wherein the estimating the information type comprises:
deriving a phrase from the text; and
selecting a target information type of a statistical model that includes a plurality of different target information types, wherein the selected information type indicates the phrase is likely to correspond to the target information type.

23. The method of claim 19, wherein determining the quality level comprises:
determining a first score for the application;
determining a second score based on a length of the time period; and
determining a quality level from the first and second scores.

24. The method of claim 21, wherein determining the quality level comprises:
determining a first score for the application;
determining a second score based on a length of the time period;
determining a third score based on the information type; and
determining a quality level from the first, second, and third scores.

25. The method of claim 19, further comprising:
determining a period of silence of the call; and
adding the period of silence to the first entry.

26. The method of claim 25, wherein determining the quality level comprises:
determining a first score for the application;
determining a second score based on a length of the period of silence; and
determining a quality level from the first and second scores.

27. The method of claim 19, further comprising:
determining a second identifier that identifies a caller for a call from the text; and
adding the second identifier to the first entry.

28. A method of categorizing units of work and their times, the method comprises:
identifying signature pages from each application page selected on a computer that includes a unique transaction identifier;
performing sequential pattern mining during a given period to extract patterns of frequently occurring application events;
partitioning another period of application events based on the identified signature pages to generate units of work;
scoring each extracted pattern based on how closely the corresponding extracted pattern matches with the each of the units of work;
determining whether each work unit is one of a normal case or a deviated case based on the scores;
determining starting and ending times of the normal cases; and
outputting the starting time, ending time, and an activity type for the normal cases that are not due to an inadvertent selection of an application.

29. The method of claim 28, further comprising:
post-processing the deviated cases to determine transactions contained in the deviated cases;
determining starting times, ending times and activity types for each of the transactions contained in the deviated work units; and
outputting the starting times, ending times and activity types for each of the transactions contained in the deviated work units.
